(19) United States
(12) Patent Application Publication
(10) Pub. No.: US 2010/0050093 A1
(43) Pub. Date: Feb. 25, 2010

(54) Collaborative Panel Adminstrator

(75) Inventors: Clifford A. Behrens, Madison, NJ (US); Devasis Bassu, Bedminster, NJ (US); Hyong Sop Shim, Basking Ridge, NJ (US)

Correspondence Address: TELCORDIA TECHNOLOGIES, INC., ONE TELCORDIA DRIVE 5G116, PISCATAWAY, NJ, 08854-4157, US

(73) Assignee: TELCORDIA TECHNOLOGIES, INC., Piscataway, NJ (US)

(21) Appl. No.: 12/258,794

(22) Filed: Oct. 27, 2008

Related U.S. Application Data
(60) Provisional application No. 61/000,620, filed on Oct. 26, 2007.

(51) Int. Cl. G06F 3/00

(52) U.S. Cl. 715/753

(57) ABSTRACT

A collaborative panel administrator provides virtual panel lifecycle management to a wide variety of data acquisition and analysis services. Broadly, it supports three types of functionalities—it provides panel lifecycle management functions; it acts as a service plug-in registry allowing various data acquisition and analysis services to register with it and extend its functionality; and, it acts as a client for the registered analysis services by invoking them on user requests and then storing and distributing the results according to panel security policies.

### CROSS-REFERENCE TO RELATED APPLICATIONS

This application claims the benefit of U.S. Provisional Application No. 61/000,620, filed on Oct. 26, 2007, which is incorporated by reference herein in its entirety. This application is also related to U.S. patent application Ser. No. 11/218,015, filed Sep. 1, 2005, which is incorporated herein by reference in its entirety.

### STATEMENT REGARDING FEDERALLY SPONSORED RESEARCH OR DEVELOPMENT

This invention is based upon work supported by the Space and Naval Warfare Systems Center under Contract N66001-03-C-8005.

### FIELD OF THE INVENTION

The present disclosure relates generally to collaborative panel administrator.

### BACKGROUND OF THE INVENTION

Human expertise and knowledge, especially when collaborated among experts, may provide valuable information in addressing many problems and solutions in various domains. While there seems to be growing interest in finding new ways of harnessing collaboration to improve the quality of knowledge and models, there remain skeptics who believe that human expertise is unreliable, and that teaming, especially collaborations that require face-to-face meetings, are too expensive. Same-time, same-place arrangements for convening panels do not allow for systematic qualification of panelists and validation of their knowledge or post hoc refinement of intelligence models as new information becomes available.

In Computer Supported Cooperative Work (CSCW), research has been conducted in the area of providing virtual collaborative workspaces in a distributed environment. For example, Multi-User Dungeons (MUDs) (described in P. Curtis, and D. Nichols, “MUDs grow up: social virtual reality in the real world,” Proceedings of the Third International Conference on Cyberspace, May 1993) have often been used to create online workspaces based on a “room” metaphor. In such a workspace, geographically distributed users can roam from room to room and manipulate the state of objects in a given room. Users can also meet in a room or hallway, either by chance or by appointment, and interact with each other. TeamRooms (described in M. Roseman, and S. Greenberg, “TeamRooms: network places for collaboration”, Proceedings of the ACM 1996 Conference on Computer Supported Cooperative Work, pp. 325-333, November 1996) provides a shared workspace on the computer desktop, in which a given group of collaborators can share resources (e.g., documents and URLs to websites), communicate (e.g., by leaving notes and/or by exchanging instant messages or group-chatting), and share information (by brainstorming). UARC (described in S. Subramanian, G. R. Malan, H. S. Shim, J. H. Lee, P. Knoop, T. E. Weymouth, F. Jahanian, and A. Prakash, “Software architecture for the UARC Web-based collaboratory,” Internet Computing, IEEE, 3(2), pp. 46-54, 1999) is one of the earliest, large-scale online collaboratories (T. A. Finholt, T. A. “Collaboratories,” in Annual Review of Information Science and Technology, vol. 36, B. Cronin, Ed. Washington, D.C.: American Society for Information Science and Technology, pp. 73-107, 2002) designed to help geographically distributed scientists conduct their science on their own, while, at the same time, allowing them to share data and conduct collaboration on an as-needed basis (e.g., when a scientist detects data of significance to others, she or he can alert them and synchronously share a view of the data). UARC also has room-based virtual workspaces where scientists and system administrators can visit and discuss research/system-related issues; report bugs and usage experience, and conduct social interactions.

Greater collaboration among teams or panels of subject matter experts (SMEs) in gaming and decision-modeling improves the quality and timeliness of knowledge. The expert panels should involve bright and qualified individuals, regardless of the time or location of their communications, who are tasked to produce models from their collective knowledge in a more-timely and less-costly manner. At the same time, those models should be valid and reliable for utilization. For this purpose, collaboration among SMEs cannot happen in an unsupervised manner; it needs to be conducted based on a well-defined process throughout the entire lifecycle of the panel for maximum effectiveness. Furthermore, it needs to involve more rigorous sampling procedures, quantitative analysis tools, metrics, etc. for qualifying the SMEs and vetting the knowledge they produce at various stages during the panel lifecycle.

### BRIEF SUMMARY OF THE INVENTION

A method and system for collaborative panel administrator are provided. The method, in one aspect, may comprise creating a computer-implemented workspace for a collaboration session and creating a virtual team including at least one administrative user. The method may also comprise creating at least one data acquisition instrument and creating a virtual expert panel to include members selected according to competency in one or more knowledge domain. The method may further comprise convening the virtual expert panel to acquire response data from the members of the virtual expert panel and analyzing the acquired response data.

A system for collaborative panel administrator, in one aspect, may comprise a computer platform module operable to provide virtual panel lifecycle management. A storage device stores a plurality of panel security policies. A plurality of service plug-in registry interfaces is implemented in the computer platform module for one or more data acquisition services and one or more analysis services to register services with the computer platform module. The computer platform module may be further operable to invoke the registered data acquisition services and the analysis services based on user requests, and to store and distribute results based on said panel security policies.

A program storage device readable by a machine, tangibly embodying a program of instructions executable by the machine to perform methods describe herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 provides an example of a typical expert panel lifecycle.

FIG. 2 illustrates an example overview UML use case for the CPA in one embodiment of the present disclosure.

FIG. 3 shows an example UML class diagram for a CPA workspace in one embodiment of the present disclosure.

FIG. 4 shows an example UML class diagram for a CPA panel in one embodiment of the present disclosure.

FIG. 5 shows an example UML class diagram for a CPA analysis service in one embodiment of the present disclosure.

FIG. 6 shows an overview of the architecture in one embodiment for the CPA.

FIG. 7 shows a component diagram for an example implementation of the CPA of the present disclosure in one embodiment.

FIG. 8 shows an example of the Schemer applet's rendering of results of a consensus analysis.

### DETAILED DESCRIPTION

Collaborative Panel Administrator (CPA) refers to a collaboration framework that manages the lifecycle of virtual teams of domain experts working in collaborative knowledge work, e.g., building ontologies, developing model scenarios, and making technology forecasts. By virtual, it is meant panels or teams whose members may be distributed in space and time. Individual panelists may submit model inputs incrementally and asynchronously, e.g., at the individual's own convenience. By collaborative, it is meant that panelists, if desired and further supported by policy, may collaborate with each other over distance and time by using both synchronous and asynchronous means of communication and information sharing.

In one aspect, the CPA of the present disclosure is guided by sound experimental research design, for example, collecting and analyzing response data from experts according to established scientific principles so that these data and the knowledge derived from them are representative and reliable, rather than from a small subsample of data that is unbalanced and unrepresentative, and which can cause severe statistical biases in resulting models. In other words, the CPA of the present disclosure in one embodiment allows for vetting of the information collected from panelists and quantitatively validating the knowledge built from this information. The framework may be deployed as a J2EE™ application and provide extension points to integrate services to foster collaboration among panelists and analyze the information acquired from them. The CPA of the present disclosure in another aspect may be integrated with a commercial collaboration platform.

Functionalities provided by the CPA's expert panel lifecycle management may include but are not limited to:

Recruitment of the “most qualified” SMEs to panels.

Access to a variety of tools to model the problem at hand. (A tool may be an instrument for collecting the data from panelists needed to derive a consensus model and/or perform other analysis.)

Timely and balanced data collection based on the properties of accumulated data.

Quantitative validation of models derived from the input of expert panelists.

Access to various analysis services for evaluation of these models.

Secure and anonymous communication between expert panelists.

Location-free collaboration at the convenience of the experts.

Secure access to consensus-derived knowledge based on roles.

An infrastructure that can build upon existing collaboration tools and in-house information technology (IT) environment.

CPA of the present disclosure in one embodiment includes data acquisition planning functionality for acquiring representative expert data, which can be used, for example, for meaningful analysis. It collects data from expert panelists so as to balance responses across the panelists and instrument items, given properties of the accumulated data.

An aspect of the CPA of the present disclosure in one embodiment may include a dynamic, adaptive data acquisition plan for virtual collaborative environment, for instance, one that does not impede interactions or overburden collaborators. The CPA, in another aspect, may utilize the feedback to expert panelists about the distribution of domain knowledge within the panel. This feedback provide measurement of consensus knowledge that it has derived from panel data, and also serves as a motivator for panelists to collaborate with each other (e.g., expert Bob realizes that he has very different ideas from expert Alice based on the feedback—this prompts him to ask Alice if she has some other evidence that made her respond differently. This may further lead to Alice uploading some evidence documents into the shared panel space which can then benefit Bob and other experts on the panel.). Schemer Consensus Analysis™ service may be used to provide such feedback. This service may be made available within the CPA as an analysis service plug-in. Schemer Consensus Analysis™ service is described in C. Behrens, and H. Shim, “Web services for knowledge-driven collaborative modeling,” a paper presented in a session entitled, IT for Counterterrorism, Proceedings of the 2004 IEEE Aerospace Conference, vol. 5, pp. 3229-3239, 2004; C. Behrens, D. Bassu, and H. Shim, “Mapping domain expertise within teams: visual stimulation of knowledge-building through collaboration”, Proceedings of the 4th International Symposium on Knowledge Domain Visualization (KDViz 2005), pp. 129-134, 2005; and C. Behrens, H. Shim, and D. Bassu, “Schemer: consensus-based knowledge validation and collaboration services for virtual teams of intelligence experts,” in Emergent Information Technologies and Enabling Policies for Counter Terrorism, R. Popp and J. Yen, Eds. Hoboken, N.J.: Wiley/IEEE Press, 2006, Chapter 11. Those papers are incorporated herein by reference in their entirety.

The CPA of the present disclosure in one embodiment is designed as a framework, defined by a set of J2EE™ interfaces, which can be implemented on a variety of collaboration platforms. For instance, the CPA may be implemented on the Vignette Business Collaboration Server™ (VBCS) by Vignette Corporation (described in URL: http://www.vignette.com), which is a commercial collaboration platform. That description is incorporated herein in its entirety.

Yet in another aspect, the CPA of the present disclosure may handle scenarios where a strategic problem needs to be solved quickly, but the needed data is not readily available to support gaming and decision-making activities. In cases like these, the CPA may provide a framework to recruit and convene a panel of domain experts so that solutions can be derived from their collective knowledge.

In the following section, an example use case is described to explain the CPA framework.

### Use Cases

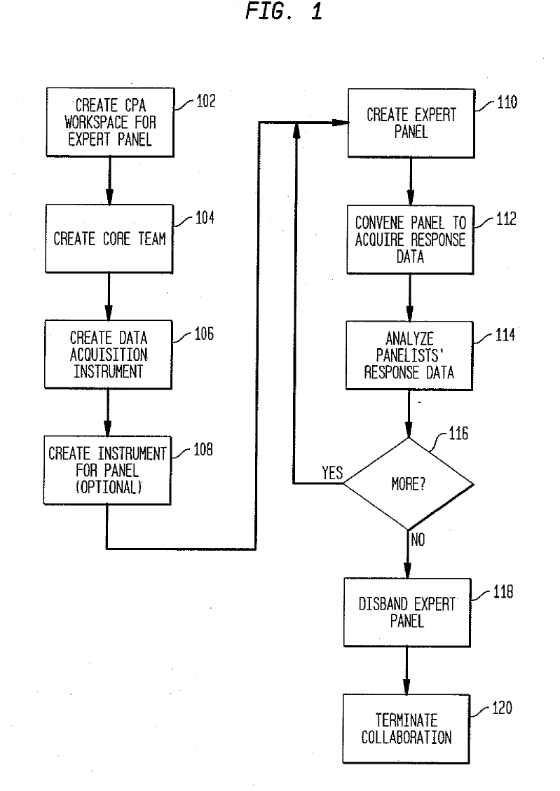

FIG. 1 provides an example of a typical expert panel lifecycle. At 102, the cycle begins with an event, e.g., a formal request or directive, which triggers the need for collaborative modeling. For example, a senior analyst assumes the administrator role and initiates collaboration by creating a workspace for it. In one embodiment, a workspace may be a permanent directory location named and created by an administrator where all administrative information, documentation, data collection forms or “instruments,” data, derived knowledge and panel lifecycle history is stored. The CPA framework provides a function to create a workspace using, for example, methods implemented in the base collaboration environment.

CPA may be realized as a Web application, which a user can use via the user's Web browser application on his or her computer that can connect to the Internet. In such an embodiment, a workspace is a set of Web pages, where authorized users can visit and gain access to a shared set of resources, e.g., URLs to Web sites and documents, and perform a set of tasks. To create a CPA workspace, an analyst first visits and logs into the CPA web site using his or her Web browser application. Then, the analyst creates the workspace by clicking appropriate links on the CPA Web pages and performing a set of operations for the CPA application for creating a workspace. Such operations include providing the name and description of the workspace, specifying the start and end time of the workspace, and optionally entering the contact information of the members of the core team for the workspace (see below).

As an example, CPA may be realized as a Web application hosted by a J2EE™ application server, and its data is stored in a database (DB) system connected to the application server. Workings of J2EE™ and database systems are well-understood by the person of ordinary skill in the art, and thus will not be explained in detail further. In addition, the computing processes that take place to create, store, update, and delete application data in a database system in a Web application that uses J2EE™ are well-understood by the person of ordinary skill in the art. When the analyst finishes creating the workspace, for example, by clicking on the “Create Workspace” button on a CPA Web page, the CPA application updates a set of database tables to store information about the new workspace.

In CPA of the present disclosure in one embodiment, the analyst who creates a workspace becomes the Administrator of the workspace. At 104 a team is created, for instance, initially having the administrator. As an optional subsequent step, he or she may recruit other analysts by adding them to the core team associated with the workspace. This may be accomplished by adding the names and contact information for each of these other analysts, and creating subspaces for each in the collaboration workspace. Members of the core team assume the lead role within the workspace. The core team always has at least one member, namely the administrator. The information about the core team for the workspace is stored in the CPA's database and is updated as per any changes made by the administrator of the workspace.

A CPA workspace is conceptually similar to shared workspaces in Computer Supported Cooperative Work (CSCW) in that it serves as the common (online) place where SMEs come together, gain access to shared artifacts, and perform their work. In the CPA of the present disclosure in one embodiment, SME activities in a CPA workspace are managed by the CPA over the entire panel lifecycle. In addition, direct collaboration among SMEs may be guided by an awareness of disparities in their contributions to the consensus knowledge, e.g., collaborative model, being produced, not by scheduled or chance meetings. To that end, the CPA of the present disclosure may automatically provide to the panel members, an understanding of the degree to which an expert's inputs are different from those of others and the consensus knowledge derived from all inputs.

Specifically, in CPA, the administrator allows SMEs to graphically view how similar or dissimilar they are in terms of their input to the model being produced by making the consensus analysis service, for example, of Schemer Web Service available to them. Such web service consensus results are presented to the SMEs as a special type of an application program, for example, as Java™ applet. This applet is downloaded and run in the Web browser application when an SME views the Schemer consensus analysis results in the CPA workspace and allows him or her to contact the other SMEs through the graphical presentation of the consensus analysis results. See FIG. 8 for an example of Schemer consensus analysis results.

Referring to FIG. 1, at 106, the core team develops a data acquisition instrument within the workspace (i.e., a workspace instrument). A data acquisition instrument may be a form, e.g., a survey or questionnaire, used to collect responses from experts. This instrument may be used for gathering data about the problem from a virtual panel of domain experts. The collected data may then be subject to various types of analysis by the core team to help them reach decisions. The type and nature of this instrument may be decided based on the nature of the problem to be solved. CPA of the present disclosure also provides extension points for plugging-in a variety of instrument types. Extension points refer to interfaces or links (or URLs) to instruments so that they become part of the collaboration workspace and are made available to all expert panelists. Instrument types may be distinguished by their formats and their measurement scales, e.g., data may be measured on nominal, ordinal, interval or ratio scales.

One method of creating the data acquisition instrument is uploading to the CPA a file that contains the instrument and instrument metadata, e.g., instrument name, data collection start and end date, the number of items in the instrument, and item data type. The file organizes the instrument and its metadata in a format required by the CPA so that the CPA can parse the file to extract and store the instrument metadata and instrument items in the database system. The operation of uploading a file to a Web site is well known and understood in the art. In CPA of the present disclosure in one embodiment, the instrument metadata and instrument items created from an uploaded file are Web forms that are downloaded to the Web browser application of an SME, the process of which is well known in the art.

Once created, however, CPA tests each instrument as an opaque object. Specifically, CPA does not know anything about the instrument exception for the instrument metadata. CPA stores each instrument in the CPA database as a byte array and downloads it to the Web browser application of an SME when he or she wants to enter data. This way, instruments can be updated without affecting CPA functions (other than that CPA software module that parse uploaded instrument files). Also, new instrument formats can easily be supported. For example, instead of Web forms, an instrument may be a software program that gets downloaded, installed, and run on SMEs' computers.

Another method of creating the data acquisition instrument is to create a Web application for creating and updating instruments. Such an application may define a process for creating and/or updating an instrument. A set of Web pages is also implemented, each of which provides a graphical user interface (GUI) that allows the user to perform one or more tasks in the instrument creation/update process. For example, at the start of the process, the application sends a Web page to the user's Web application that allows the user to enter instrument metadata. When the user completes this task and submits the data (say, by clicking on the “Submit” button on the page), the application sends another Web page where the user can define an instrument item. At the end of the process, the application stores the submitted instrument metadata and instrument items in the CPA database.

CPA of the present disclosure in one embodiment allows different instruments to be created to be used for different workspaces, but the same instrument creation/update process is used. CPA may define a process for creating and/or updating instruments by means of a set of CPA Web pages. In CPA, each instrument may be treated as an opaque object, i.e., CPA does not know the exact details about the instrument. CPA stores each instrument in the CPA database as a byte array and downloads it to the Web browser application of an SME when he or she requests it to enter data. CPA collects information to facilitate balanced data collection, for example, as part of the instrument creation process. Examples of information collected may include but not limited to the number of questions in the instrument and the data type of answers.

At 108, the core team creates a virtual panel of domain experts. Based on the complexity of the instrument and the range of data to be collected, the core team may decide to create more than one virtual panel. In one embodiment, a virtual panel includes a collection of subject matter experts who may collaborate asynchronously, e.g., not face-to-face, due to their different physical locations. Members of the virtual panel include those who have accepted invitations from the core team to participate in the collaboration. These invitations may be created through functions supported by the CPA linked to methods implemented in the base collaboration environment. These panels may be topical, where a game or decision may involve a variety of sub-disciplines, e.g., economics, political science, military history, legal, etc. In such a case, the workspace instrument may be partitioned into smaller panel instruments, one for each panel. As illustrated in FIG. 1, managing a virtual panel comprises of a series of sub-tasks which may be repeated. The CPA of the present disclosure may include functionalities for carefully selecting a group of experts, qualifying them, then weighing their data inputs by estimates of their competency in the knowledge domain, rather than merely taking the simple majority view from a large group of experts.

For instance, at 110, SMEs may be invited to join the panel. Experts may be recruited in a number of ways. This may range from manual selection to more sophisticated techniques like searching skill profiles, “snowball” sampling, social network analysis of a literature citations index, or recommendations of authors based on a content analysis of their documents. The core team may utilize such a multi-option recruitment capability to go about assembling panels, for example, on a short notice. Experts often may not be geographically co-located—it is only sufficient that they be available over the Web or like computing environment. An invited expert may have the option of declining the invitation. Invitations may be extended by members of the core team, or by those who have already accepted an invitation.

At 112, once enough domain experts have accepted invitations to serve, the panel may be convened to acquire data from it. For example, once the CPA has recruited the panelists needed and the core team has created a data collection instrument, the CPA administers instruments to panelists and acquires data. This is done according to a schedule created by the administrator, and following experimental research design. The determination as to what constitutes enough domain experts is based on the availability of experts to serve on the panel and the length of the data collection instrument, and these may depend on the domain or subject matter being considered, the depth of expertise already gathered, etc. Each panelist is given his/her own copy of the appropriate panel instrument to collect response data.

The data is gathered that, for example, meets minimal quality criteria. For instance, under the fully controllable circumstances, the experimental research design described in D. Montgomery, D., Design and Analysis of Experiments, 6th Edition. New York: John Wiley & Sons, 2000 may be used to obtain balanced datasets. However, full control is not always likely in this case of gathering data from a virtual panel due to a variety of factors large number of instrument items, incomplete input from an expert, short time span to complete the data collection, etc. To address such factors that may occur, the CPA of the present disclosure in one embodiment provides and utilizes a data acquisition plan that is dynamic in nature (e.g., based on the panelist responses at any time) and that guides (without overburdening) panelists to provide subsequent responses in a manner that balances the panel dataset. Dynamic data acquisition is a plan, computed by the CPA, for assigning items (or questions) to panelists based on the data that have already been collected. The data acquisition plan attempts to ensure that data collection is evenly distributed, both across panelists and instrument items. In addition to providing such a data acquisition plan, the CPA may carry out the data acquisition within a time boundary. The time boundary may be set or predetermined, and may be modifiable, for example, by a panel administrator. The panelists may be sent timely reminders and notifications so that deadlines are met. For instance, the CPA determines the data it needs, from whom to get it, and monitors those who have not yet responded to data input requests. The CPA may be programmed to automatically collect the same number of responses for each item (or question) on the instrument and in a way so that no panelist is asked to answer more items than any other panelist.

At 114, once data collection has commenced, the core team may start performing preliminary analysis on the aggregated panel data. A variety of instrument types may be used for data acquisition and different types of data analysis may be performed depending on the nature of the problem. In one aspect of the CPA of the present disclosure in one embodiment, extension points are provided for plugging-in different analysis services. The core team is also provided with indicators/metrics about the quality of the panel data being collected. For example, the Telcordia™ Schemer Consensus Analysis™ service may be used to determine or gather these sorts of metrics including, for example, both visual and quantitative indicators for knowledge validation. Such analyses may be provided to panelists, which would further motivate additional collaboration amongst the panelists, also promoting consensus-building and knowledge improvement. The CPA framework may be integrated with existing collaboration tools (which already may be familiar to users) and leverages the functionality of these tools. An associated problem with most statistical techniques is that they require a complete dataset, one with no missing values. The CPA provides an imputation service that overcomes this problem. The purpose of this service is to create a complete panel dataset from an incomplete one by applying proven statistical data imputation techniques. It also provides indicator(s) of how much the panel dataset is affected due to the artificial injection of missing data; hence its effects on the result of any subsequent analysis on these data.

In another aspect, the CPA framework includes a set of access policies. For instance, depending on the sensitivity and nature of the problem, a virtual panel may be convened while maintaining complete anonymity of participating experts. Since anonymity should not impede collaboration between experts, aliases may be used. For further security, some data shared by core team members may not be accessible to all or selected panelists.

The results obtained from data analyses can implicate another round of data acquisition, possibly with new experts, or can reveal that the computed model is stable, so no more data acquisition is necessary. At 116, if more data is to be acquired, the method returns to 110. If not, at 118, the panel may be disbanded, and the collaboration terminated at 120. For example, an administrator may disband the panel using a CPA function, and its links to methods in the base collaboration environment, to deactivate the collaboration workspace. Once a panel or workspace is no longer active, read-only access policies may be applied so that the data and results are available for reference later on. Optionally, the data may be deleted.

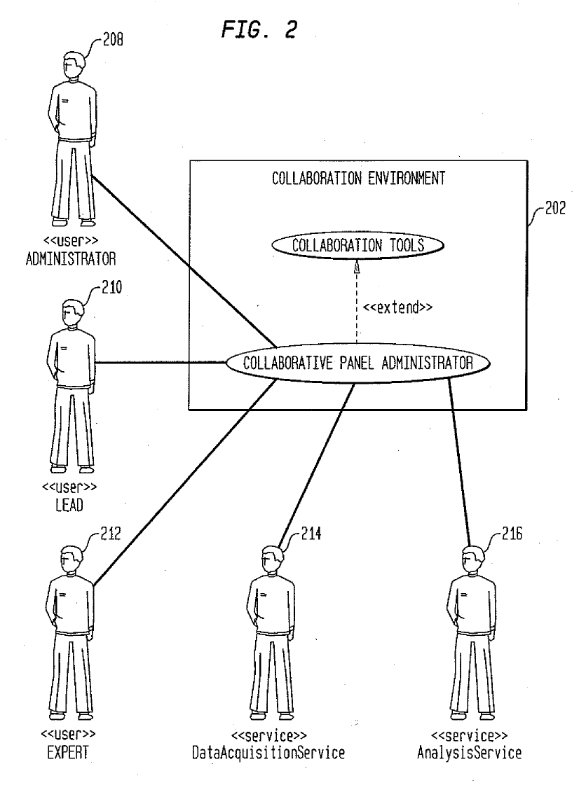

We present the information model with a detailed discussion on the model elements and model features. The following description uses the Unified Modeling Language (UML) to represent the CPA model. UML is described by The Unified Modeling Language, Object Management Group (URL: http://www.uml.org) and UML tutorials (URL: http://www.uml.org/#Links-Tutorials). The UML diagrams of FIGS. 2-5 are shown only as examples and illustrative purposes. Those diagrams do not limit in any way the scope of the present disclosure. Thus, other implementations and models may be used to realize the CPA of the present disclosure.

### Information Model

FIG. 2 illustrates an example of the overview UML use case for the CPA. The CPA extends functionality provided by currently available collaboration platform/tool(s) to include expert lifecycle management. The use case introduces the various CPA actors (user roles and external service roles). Table 1 lists the various CPA elements which comprise the CPA model. The CPA model is not limited to only those listed. These are explained below in more detail with the aid of UML class diagrams.

TABLE I
CPA model elements.

| Actors | Roles |
|---|---|
| Administrator | Creator of a CPA workspace. Non-removeable |
| | member of the core team for this workspace |
| | (i.e., lead member). |
| Analyses | Container for holding analyses performed on |
| | one or more instruments. |
| Analysis | Stores a single analysis - may contain the input |
| | data, other parameters and the result |
| CoreTeam | Group of lead users associated with a CPA |
| | workspace responsible for creating new |
| | reference instruments, convening panels and |
| | carrying out analyses on the gathered data. |
| CPAFactory | Factory to obtain handles to new CPA session |
| | objects. |
| CPAObject | Base for all CPA objects. |
| CPASession | Provides role-based access to the CPA |
| | workspaces/panels in addition to some search |
| | functionality. |
| DataAcquisitionPlan | Plan for data collection for an expert panel |
| | based on balanced incomplete block design |
| | (statistical experimental design). |
| Expert | Knowledge domain specialist who is invited to |
| | a panel to provide his/her input (data) for a |
| | particular instrument. |
| Lead | Member of the core team for a CPA |
| | workspace. |
| Metadata | Container for additional information associated |
| | with a CPA workspace and a CPA panel |
| Panel | Provides functionality to select a group of |
| | experts for acquiring data for a specified |
| | instrument. |
| Panelists | Group of experts associated with a CPA panel |
| | responsible for providing their responses (data) |
| | to items on the panel instrument. |
| ServiceCallback | Extension mechanism for external services to |
| | interoperate with the CPA |
| ServiceRegistry | Provides access to registered services with |
| | query functionality. |
| User | Generic user of the collaboration environment. |
| Workspace | Top-level container for any operation within |
| | the CPA. |

The CPA 206 of the present disclosure extends a base collaboration environment 202, to include collaboration tools 204 and collaborative panel administrator functionality 206. A core team comprising, for example, an administrator 208 and a lead 210 may elicit a panel of one or more experts 212. Data acquisition service 214 gathers expert data and an Analysis service 216 performs analysis of the gathered data. For example, CPA's data acquisition service administers data collection instruments to panelists, based on the computation of a data acquisition plan, and stores these data in the collaboration workspace so that it can be processed and analyzed. CPA's analysis service provides an interface through which analysis services, e.g., the Schemer consensus analysis service, can process the expert panel response data.

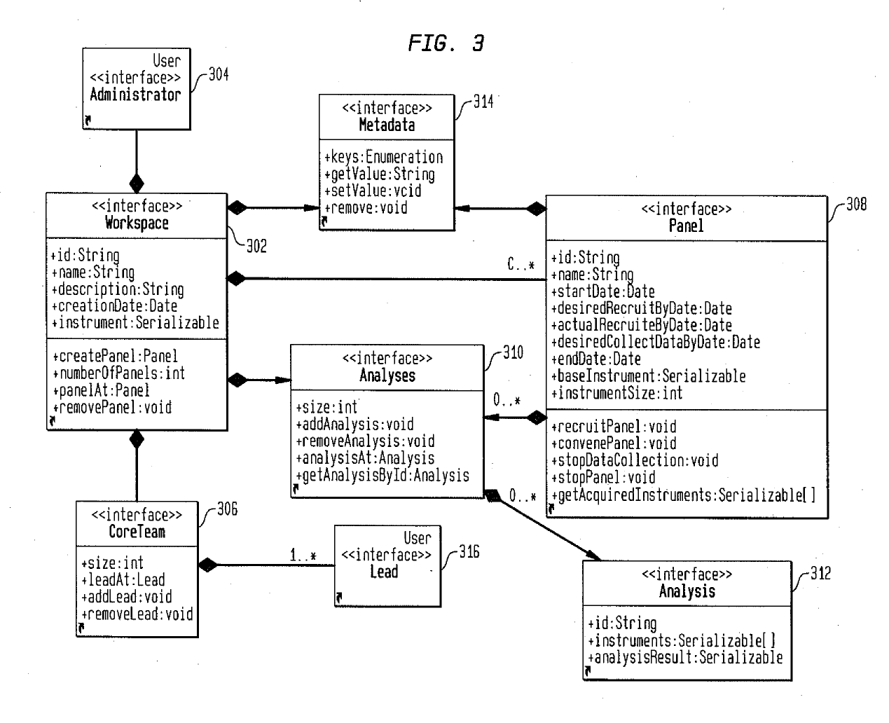

FIG. 3 shows the UML class diagram for a CPA workspace. A CPA workspace 302 is created before carrying out any expert panel activity. In one embodiment, the creator is assigned the administrator role 304 and is automatically added to the core team 306. The core team may contain other lead members 316 (in addition to the creator) who are in charge of managing this workspace. A workspace 302 typically contains one or more CPA panels 308. The CPA allows for analyses 310 to be carried out for both the workspace 302 and its constituent panels 308. Analysis 312 stores a single analysis and may contain the input data, other parameters and the results of that analysis. Workspaces 302 are uniquely identifiable within any CPA environment and may be accessed via the administrator or the lead roles using the CPASession object. Metadata 314 is a container for additional information associated with a CPA workspace and a CPA panel.

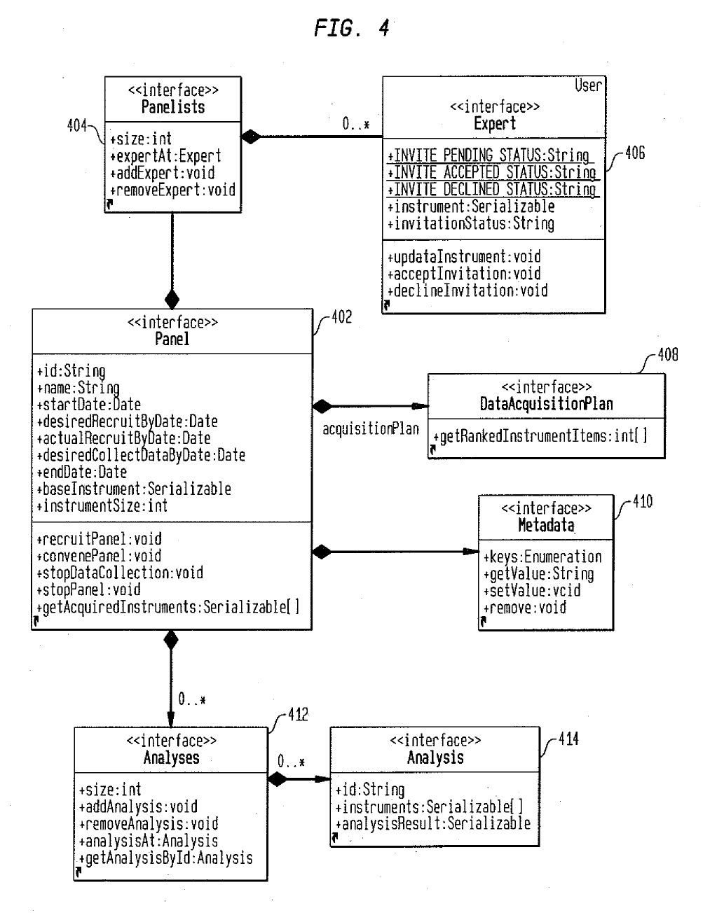

FIG. 4 shows the UML class diagram for a CPA panel. Panels 402 are contained within a workspace and are managed by any core team member of the associated workspace. The panel 402 provides functionality for carrying out the various lifecycle operations (informed by workflows illustrated in FIG. 1). Panels are uniquely identifiable within their parent workspace. In addition, the panel 402 maintains detailed information about domain experts 406 who have been invited to join the panel 402. It keeps track of the instrument updates for experts who are active members (panelists) 404. This allows the panel 402 to provide a functionality of a data acquisition plan 406 based on statistical experimental design techniques. The data acquisition plan 408 is used by a data acquisition service to request input from a panelist according to the plan. The plan is updated in real time as panel data accumulates. The data acquisition plan 406 also provides an aliasing mechanism through which all panel operations may be executed in complete anonymity. Expert panelists 404 are assigned aliases which are used in all operations even to the extent of providing labeled data to the analysis services. The panel object provides basic functionality for experts to communicate with each other using these aliases. Metadata 410 is a container for additional information associated with a CPA workspace and a CPA panel. Analyses 412 is a container for holding analyses performed on one or more instruments, and Analysis 414 stores a single analysis and may contain the input data, other parameters and the results.

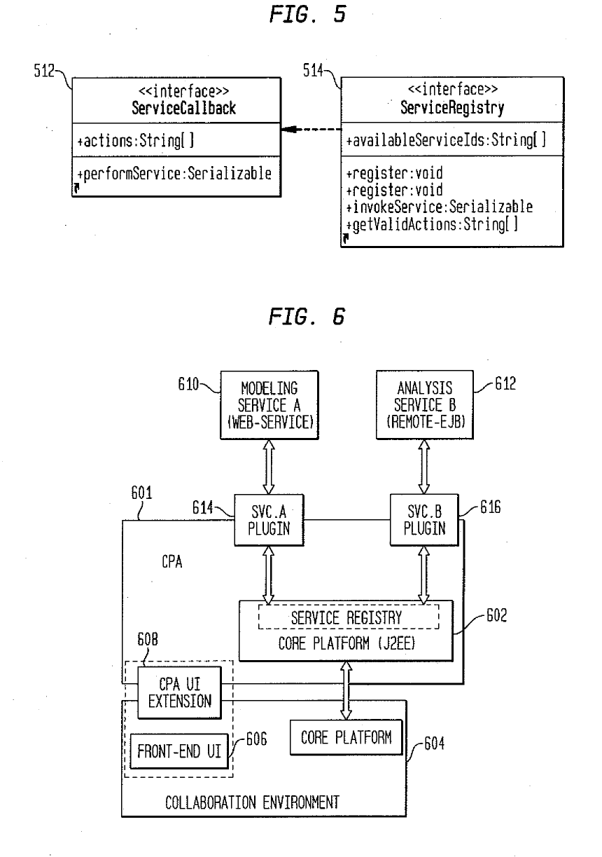

FIG. 5 shows the UML class diagram for a CPA analysis service. An analysis service may perform various types of operations (actions). It advertises these actions via the ServiceCallback 502 and also allows the CPA to invoke a particular action in a generic fashion. The CPA does not put any restriction on how the actual service is implemented. The ServiceRegistry 514 provides a listing of all services currently registered with the CPA in addition to basic service operations.

Integration with External Services

The CPA facilitates analysis and validation of response data collected from an expert panel. Different panels may be associated with different knowledge domains, each requiring a unique data model and possessing its own requirements for data validation and analysis. The CPA provides a general framework for representing and interacting with external data analysis and validation services. The operation and management of the CPA is kept separate from the services of data analysis and validation facilities. The CPA provides a Service Registry 514, through which external services can register with the CPA. The registration involves a Service Callback object 512 that the service sends to the Service Registry 514. The CPA interacts with the registered service via the Service Callback object 512. It defines a set of APIs that allow the CPA to query for and invoke operations made available by the service. Registered services are available for use in CPA panels.

### Panel Data Aggregation

The CPA collects data from expert panelists. On command by a lead, the CPA aggregates these data prior to submitting them to a registered service for analysis. The CPA defines an information model of a panel instrument that involves the basic concepts of panelists (identified by the CPA-generated aliases), items (or questions on a data acquisition instrument) and panelist responses to the items. Individual services define the aggregated data format for a CPA panel instrument. To this end, the CPA defines an interface, referred to herein as a Data Aggregator. It also defines a single API method that the CPA can use to aggregate collected data as per a target service. Since panelists are identified by the CPA-generated aliases in the CPA panel instrument, information on who has responded to which item with what value is also specified in terms of panelist aliases in the aggregated data. Each service implements and sends a Data Aggregator object when it registers with the CPA.

### Data Analysis

The CPA provides the Analysis object for representing an invocation of a registered analysis service. Each Analysis object is time-stamped and assigned a unique identifier and provides a consistent interface for the CPA to retrieve, upon command by an authorized panelist, the results of an analysis operation. At the same time, individual services control the manner in which analysis results are retrieved. For example, a service may return a URL to the analysis results in an Analysis object, so that retrieving the results from this object generates an additional request to the service. This way, the service can provide the result of the analysis as raw data (viewed as text), and additionally provide a renderer, e.g., an applet, which may present a more useful view of the result to the end user. Schemer™ makes use of this capability to allow panelists to view and interact with others via its consensus analysis results on the Web.

URL is a universal data type whose semantics is understood by most systems, and the CPA recognizes and makes an appropriate HTTP request upon recognizing that the data retrieved from an Analysis object is a URL. In general, analysis results may be opaque to the CPA, and the CPA does not know and does not need to know how to parse and process the data in an Analysis object. Rather, the CPA defines an interface, referred to as an Analysis Handler, with a single method that takes an Analysis object, retrieves the contained data, and processes it as per the service that has returned the Analysis object. When registering with the CPA, a service may optionally provide an Analysis Handler object, which the CPA may then use to retrieve and process the data of analysis results upon panelists' commands.

### Security

A large amount of data, which is held within any given CPA workspace and its panels—instruments, analyses, metadata, expert inputs, etc., may be subject to various access policies based on the CPA roles (administrator, lead and expert). In one embodiment of the present disclosure, the CPA enforces access policies down to the underlying base collaboration environment level, i.e., all data will still be subject to access policies even if using any low-level API that may be provided by the underlying base collaboration environment.

### Software Architecture

The CPA may be implemented the Java Enterprise architecture (J2EE™) and the service-oriented architecture (SOA) paradigms. Such paradigms allow the CPA to operate as middleware and interact with different base collaboration environments and various data acquisition/analysis services. FIG. 6 shows an overview of the architecture in one embodiment for the CPA. CPA may be a framework layered on an existing base collaboration platform, and may use functions in this platform to support expert panel lifecycle management. For example, the CPA of the present disclosure in one embodiment integrates and manages, inter alia, use of functions such as email and workspaces in support of a higher-level more disciplined process.

### Platform

For example, the CPA 601 may be specified as a J2EE™ API. This allows service plug-ins to be built from API specifications and facilitates interoperability with different CPA implementations for a variety of base collaboration environments. The core platform 602 may be implemented as a J2EE™ application for providing virtual panel lifecycle management to a wide variety of data acquisition and analysis services. Broadly, it supports three types of functionalities—it provides panel lifecycle management functions; it acts as a service plug-in registry allowing various data acquisition and analysis services to register with it and extend its functionality; and, it acts as a client for the registered analysis services by invoking them on user requests and then storing and distributing the results according to panel security policies.

An implementation of the CPA 601 for any given base collaboration environment 604 minimally may include a J2EE™ implementation of the CPA API, a graphical user interface (GUI) front-end 606 for accessing the CPA functionality. The J2EE™ implementation typically reuses the collaborative functionality (e.g., storage, communication, etc.) from the base environment and does not duplicate it. The CPA user interface (UI) 608 may be an extension of the Front-End UI 606 provided by the base collaboration environment 604. This provides a “native” look-and-feel to clients of that base collaboration environment. Whenever the Front-End UI 606 is either not present or cannot be extended, the CPA UI 608 can be implemented within the J2EE™ environment of the core platform 602.

The implementation also includes policy-based storage resources to store the CPA-related data. This may be furnished by the base collaboration environment or the local IT environment. If not, this part may be implemented with the same J2EE™ environment using a database and/or a secure file system.

The CPA API provides a generic interface 614, 616 between data acquisition services 610, data analysis services 612 and collaboration tools, and is designed to facilitate CPA client integration via customizable utilities (with GUIs) for defining per-service and per-panel instruments, security policies, and data entry forms. The CPA of the present disclosure may be integrated with a variety of collaborative-modeling tools, such as SIAM INET®, and commercial groupware systems, including CPA implementations in VBCS®. In addition, analytics service such as the Telcordia™ Schemer Web Service™ may be integrated with the CPA to provide knowledge validation and collaboration services. Information specific to online services and client tools may be captured and stored in a “group memory” knowledge base for future use by panelists or their agents. Furthermore, new online services can be supported on an as-needed basis, for example, by creating service-specific agents, without affecting operations by the rest of the system.

### Services

The CPA core platform in one embodiment provides the facility to register third-party data acquisition and analysis services to extend the functionality of the CPA core platform (e.g., as discussed with reference to 602 FIG. 6). This provides a flexible architecture for evolving the CPA based on client needs over time.

Plugging a service into the CPA comprises of creating various service components. There is the service itself which may be implemented in any fashion and is not required to meet any interface (e.g., existing services). The next component is the CPA plug-in counterpart for the service which meets a certain interface and provides the CPA with a callback for it to access this service in a generic fashion. Additionally, the service may also provide other UI components, if needed or desired.

### Software Implementation

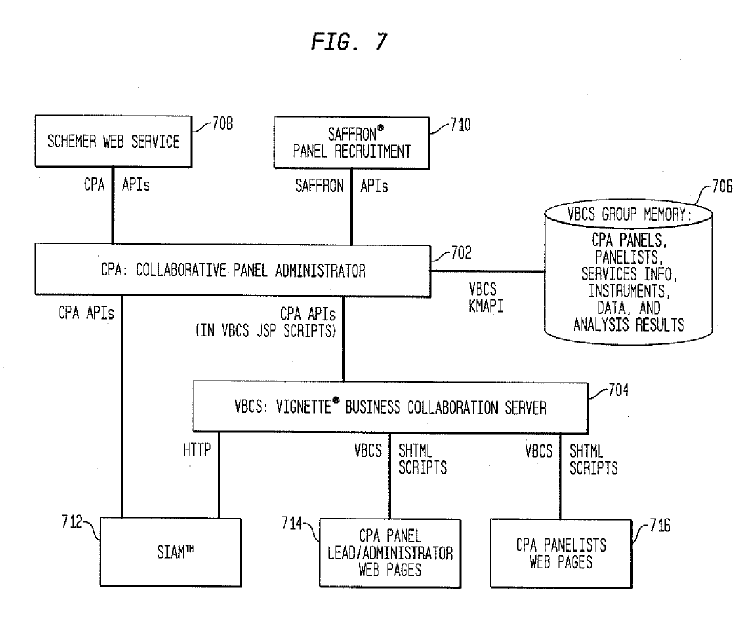

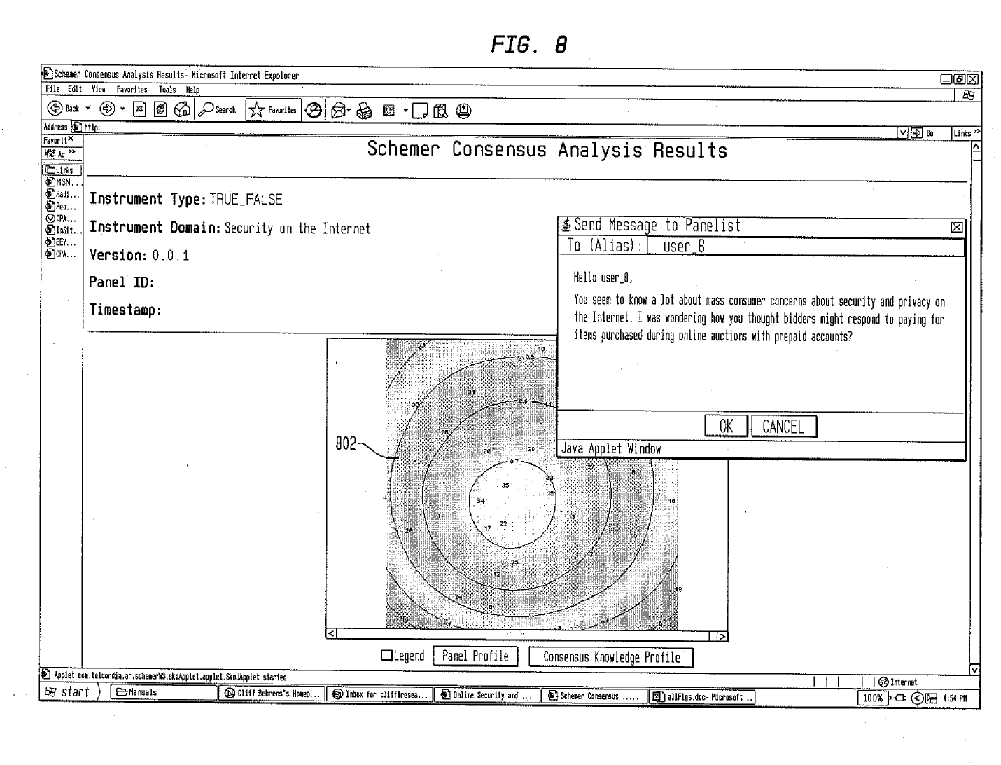

As an example, the CPA may be implemented using the JBoss J2EE™ server, which may use the Schemer Web Service™ as an analysis service. The CPA implementation may be built on the commercially available Vignette Business Collaboration Server® (VBCS). FIG. 7 shows the component diagram for this implementation.

VBCS 704 provides a base collaboration environment and exposes a Java interface for programmatic access. It also provides policy-based access to its group memory, which may be essentially thought of as a regular file system with much greater functionality. In this example implementation, the CPA platform 702 is built on the JBoss 4.0.3 server. The CPA UI is integrated with VBCS 704 using the VBCS UI framework. Two analysis services (Schemer, Saffron) 708, 710 and a data acquisition service (SIAM-WET) 712 interact with the CPA installation 702. The VBCS group memory 706 with its access-policy mechanism is used to store hierarchically all the CPA data.

In this example implementation, all the CPA workspaces are stored in a root-level folder (VBCS cabinet). A CPA workspace (VBCS folder) is created to manage resources for a community of interest (COI), in this case a panel of subject matter experts, including an instrument, results of analyses, and other information shared by Core Team (VBCS group) members. At the next lower level, another folder is created to manage information for each expert panel, organized around topics. This space holds artifacts such as panel instruments, results of analyses obtained from the panel's data, and other shared information such as email and threaded discussions. Folders exist at the lowest level to store and manage information for individual panelists, such as customized forms derived from the panel instrument. Data access privileges, assigned to roles within the CPA framework, are mapped to VBCS group memory access policies to enforce local security policies. The web pages 714 and 716 generated by the CPA for the Panel Administrator and Panelists, respectively, are used to communicate and collect information, e.g., to collect panel administration information from the Administrator, or to acquire response data from subject matter experts.

### Feature Implementations

The following presents implementation details for some of the CPA features such as core platform and service plug-ins.

### Panel Recruitment

In one embodiment, the panel experts may be manually selected from the VBCS user database. A set of new users (with valid e-mail addresses) may be loaded into VBCS, for example, if the experts need to be recruited who are not already in the VBCS user database. Panel recruitment may also include processing profiles describing skill sets and expertise of candidates listed in a groupware, e.g., Groove® or VBCS®, directory. Other recruitment methods may include but are not limited to “snowball sampling,” where an expert can nominate other experts for a panel, recruitment through citation networks where qualified experts are discovered through those who cite their publications, or by the content analysis of publications by experts, recruiting those whose publications are relevant to the current panel. The CPA provides a clean interface and plug-in mechanism for introducing new “recruitment modules” like these.

Data Acquisition Plan: Under the assumption of non-correlated instrument items, an algorithm is provided to balance panel data to ensure that the number of responses per instrument item, as well as the number of responses per panelist, is balanced across items and panelists. For example, no item has more responses than another, and no panelist is asked for more responses than any other. Further, the data acquisition plan may use a heuristic based on the number of items per instrument to determine how many “hot items” (i.e., items for which answers are most urgently needed) to put in a data acquisition plan for any given panelist. For example, the plan for collecting data from panelists includes which items to include on an instrument for a panelist.

Panel Lifecycle management: This CPA implementation provides a mix of automatic and manual management of the panel lifecycle. The lead member is asked for the “end-of-recruitment” date at the time when the lead member initiates recruitment by sending out invitations to candidate domain experts. Internally, a timer is set with the termination date. Unless overridden manually by a lead (in which case the timer can be reset), the CPA core platform terminates the recruitment phase when the timer expires. Alternatively, a lead can also prematurely terminate the recruitment phase by convening the panel and providing the “end-of-data-collection” date. In this case also, the timer is reset and notifications are sent out.

Each phase of the panel lifecycle may thus be managed automatically (based on specified deadlines) or manually. Appropriate e-mail notifications are sent out during the initialization and/or termination of each phase.

Anonymous Collaboration: This user-selectable feature may be implemented by providing automatic aliases for each panel expert (per panel). These aliases may be then used in all correspondence. In one embodiment, only the core team is able to view the mapping information from the alias to the actual expert panelist. Anonymity while using e-mails may be handled by introducing a dummy user, for example, the CPA Administrator user. All outbound emails may originate from this user with a special subject line prefix.

Schemer™ Plugin: Here, we briefly describe how Schemer's consensus analysis results are integrated with the CPA to enable knowledge-driven collaboration among CPA panelists. Detailed explanation of the Schemer Web Service is described in C. Behrens, and H. Shim, “Web services for knowledge-driven collaborative modeling,” Paper presented in a session entitled, IT for Counterterrorism, Proceedings of the 2004 IEEE Aerospace Conference, vol. 5, pp. 3229-3239, 2004; C. Behrens, D. Bassu, and H. Shim, “Mapping domain expertise within teams: visual stimulation of knowledge-building through collaboration”, Proceedings of the 4th International Symposium on Knowledge Domain Visualization (KDViz 2005), pp. 129-134, 2005; and, C. Behrens, H. Shim, and D. Bassu, “Schemer: consensus-based knowledge validation and collaboration services for virtual teams of intelligence experts,” in Emergent Information Technologies and Enabling Policies for Counter Terrorism, R. Popp and J. Yen, Eds. Hoboken, N.J.: Wiley/IEEE Press, 2006, Chapter 11, which are incorporated herein by reference in their entirety. The Schemer Web Service has a client-server architecture in which the Schemer's server process responds to clients' requests for consensus (and time-series) analysis. The server's response to a consensus analysis request contains a number of artifacts and metrics computed on the data set submitted in the client's request, including competency estimates of individual expert panelists whose data is collected in the submitted data set, a metric to determine how salient the knowledge domain is to the expert panel, and a consensus model. The server leaves it up to individual clients to process these artifacts and metrics, and renders them for the end user as per application requirements.

For integration with the CPA of the present disclosure, an applet client may be built for processing and rendering Schemer's consensus analysis results on a Web browser. Schemer includes a URL in the Analysis object that it returns to the CPA in response to a consensus analysis request (via its registered Service Callback object). The URL points to Schemer's website, from which the applet can be downloaded, and includes a Schemer-defined query parameter used to uniquely identify the analytical results of the corresponding request. When the client makes an HTTP request using the URL, Schemer dynamically creates a response HTML page with applet download instructions and initialization parameters. Once the applet is initialized on the client host, it downloads the corresponding analysis metrics and artifacts from the Schemer Web Service and renders them in a Web page.

FIG. 8 shows an example of the Schemer applet's rendering of results of a consensus analysis. In the figure, the contour image 802 is called the KMap and shows how close (apart) panelists are to (from) each other in terms of their contributions to the computed consensus model. Detailed discussion on the KMap and its semantics can be found in C. Behrens, D. Bassu, and H. Shim, “Mapping domain expertise within teams: visual stimulation of knowledge-building through collaboration”, Proceedings of the 4th International Symposium on Knowledge Domain Visualization (KDViz 2005), pp. 129-134, 2005, incorporated herein by reference in its entirety. Panelists are identified by the CPA-aliases in the aggregated data, which have been submitted to the Schemer for consensus analysis; in the KMap panelists are also identified by the same set of aliases. This way, panelists can be made aware of their respective “distances” from each other on the KMap (i.e., based on what they know) while still preserving their true identities. Awareness of panelists' locations on the KMap is a powerful mechanism for inducing collaboration among panelists, either voluntarily or at the behest of the panel administrator, to anonymously share knowledge and information. The mode of interaction between panelists may be through the Schemer applet's anonymous e-mail function and/or any other communication function, for example, provided in the base collaboration environment. For example, the user can select a panelist on the KMap shown in FIG. 8 and issue a command to send e-mail, at which point the applet displays a form where the panelist types his/her message and sends it. The message is addressed to the alias of the recipient panelist. Subsequently, the applet posts an HTTP request to the Schemer Web Service that contains the email to be sent. In turn, the Schemer Web Service makes a request to the CPA to send the email. In one embodiment, the user selects another panelist to communicate with by right-clicking on panelist aliases (shown as numbers in this example) on the Kmap 802.

The Schemer applet is implemented to be able to identify the panelist who is viewing the KMap. For instance, the CPA appends a userID parameter to the Schemer-generated URL for the Schemer applet, where userID is the alias of the panelist who is invoking the applet. The userID parameter is an example of information whose semantics are understood by both the CPA and external data analysis and/or validation services to realize an end-to-end collaboration platform. The CPA may also identify, represent, and create a general framework for communicating shared information.

### Knowledge Validation Through Consensus Analysis and Peer Review

Yet in another aspect, the CPA may use the Schemer technology to motivate use of local collaboration tools by creating greater awareness of “who knows what”. Schemer applies consensus analysis, a rigorous statistical methodology, to derive consensus models from panel data. Since the CPA enforces data acquisition plans, Schemer receives the data it needs to compute probability metrics that measure the validity of the derived model and estimates of each panelist's competency in the problem domain. Schemer also provides visualizations and metrics useful for assessing the formation of consensus and the amount of knowledge-building produced by collaborations among panelists. These metrics and visualizations help members of the core team decide when panelists are no longer likely to change their position on an issue, when a model has stabilized and, hence, when additional data acquisition is no longer likely to be productive.

### Bias Detection

Still yet in another aspect, the Schemer/CPA interaction may identify statistical bias when it occurs at anytime during a panel's lifecycle. For example, a panelist's bias is the perspective or point-of-view that he or she brings to the collaboration. By facilitating the recruitment of qualified panelists, and by acquiring data from them consistent with sound experimental research design the CPA attempts to help identify and manage distinct biases. For example, data are representative and collected according to scientifically established experimental research design. Balanced Incomplete Block Design (BIBD) is an example of such a design. To complement the CPA, Schemer provides a means for quickly identifying bias through its metrics, and point patterns in a KMap. These statistical analyses are useful for exposing novel thinkers or those who challenge the “received” view, and for revealing the sources and mitigating the effects of “group think.” Any such revelations may guide the core team in the way it manages domain experts on a panel.

### Data Acquisition Plan/Unbiased Sampling

The data acquisition plan balances the aggregated expert data for a panel. Further it does so under the assumption of independent panel instrument items. Data acquisition may also include support for correlated (2-way or more) items for a panel instrument. For instance, additional balancing of paired item responses for a simple 2-way scenario may be performed. Balanced Incomplete Block Design (BIBD) is a well-researched and understood statistical experimental design method to achieve such a plan and described in J. H. Dinitz, and D. R. Stinson, “A Brief Introduction to Design Theory,” in Contemporary Design Theory: A Collection of Surveys, J. H. Dinitz and D. R. Stinson, Eds. New York: Wiley, 1992, pp. 1-12. Close alternatives to such a plan may be performed. The BIBD algorithm may be used to compute data acquisition plans by the CPA. This algorithm is based on the number of items, the number of panelists, and the cumulative amount of data already collected. The algorithm compute a consensus model for the best data possible (i.e., “representative”), given the size of the current data, each item and panelist being sampled the same number of times.

Data acquisition may further include handling various scenarios. For example, consider a complex workspace instrument, which is to be split into two or more panel instruments for data acquisition. In this case, the plan from the viewpoint of the aggregated panel data (all expert responses for all panels within the workspace) may have to be considered. Throw in possible correlation across panel instruments and the problem is similar to the general form of BIBD with multiple blocks. An adaptive data acquisition plan under these scenarios may be computed.

### Data Imputation

In one embodiment, data imputation may be provided as a service for providing a complete dataset for processing to analysis techniques. There exists a variety of algorithms for imputing data. A recursive k-NN (k nearest neighbors) imputation algorithm with appropriate thresholds available in the impute package for R described in The R Development Core Team, The R Environment for Statistical Computing and Graphics: Reference Index Version 1.7.0, R Development Core Team, Apr. 16, 2003, incorporated herein by reference in its entirety, may be used. The underlying principle is that a panelist will tend to respond (for the missing data) in a similar fashion as other panelists who seem to match on most responses (for the collected data). For each vector of responses for a panelist, any missing values are estimated from the values of the k-nearest neighbors using, in this case, a Euclidean metric to identify neighbors. T. Hastie, R. Tibshirani, G. Sherlock, M. Eisen, P. Brown, and D. Botstein, Imputing missing data for gene expression arrays, Stanford University Statistics Department Technical Report, 1999, unpublished and O. Troyanskaya, M. Cantor, O. Alter, G. Sherlock, P. Brown, D. Botstein, R. Tibshirani, R. Hastie, and R. Altman, “Missing value estimation methods for DNA microarrays”, Bioinformatics, vol. 17(6), pp. 520-525, 2001 describe details on the CPA's imputation algorithm, which are incorporated herein by reference in its entirety.

Most of the imputation algorithms provide tuning parameters, which may be set to guide the imputation. This ability may be provided to a lead analyst. Further, metrics for any imputation that is performed on the raw data may be provided from which the analysts' may get a realistic idea of how much to rely on the analyses performed on the imputed dataset. Also, imputation details may be sent to other analysis services which may use this information in their analysis, affecting the result.

The CPA of the present disclosure provides shared workspaces in a virtual environment by way of its project workspaces and associated expert panels. Unlike known virtual environment methodologies, however, much activity in CPA panels, i.e., asynchronous data collection from distributed panelists, is guided by experimental research design techniques that places an emphasis on balanced and unbiased data collection and analysis. Direct collaboration takes place as a result of discovering latent knowledge of “who knows what” obtained from rigorous analysis of individual panelists' independent contributions to the panel, rather than from direct interactions among panelists. The built-in anonymity in inter-panelists collaboration is designed to discourage persuasion of opinions by reputation and personality, and promotes community knowledge-building, e.g., by exchanging information sources and sharing little known, but vital, pieces of information in a unfettered manner. Such knowledge-building has the potential of yielding “better” models in subsequent phases of independent data collection and analysis.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for collaborative panel administrator, comprising:
creating a computer-implemented workspace for a collaboration session;
creating a virtual team including at least one administrative user;
creating at least one data acquisition instrument;
creating a virtual expert panel to include members selected according to competency in one or more knowledge domain;
convening the virtual expert panel to acquire response data from the members of the virtual expert panel; and
analyzing the acquired response data.

2. The method of claim 1, wherein the step of creating a virtual expert panel includes selecting one or more experts and recruiting said one or more experts to participate in the computer-implemented workspace.

3. The method of claim 1, wherein the step of analyzing the acquired response data includes invoking an analysis service.

4. The method of claim 3, wherein the analysis service is implemented as a plug-in to the computer-implemented workspace.

5. The method of claim 1, further including:
repeating the steps of creating a virtual expert panel, convening the virtual expert panel to acquire response data from members of the virtual expert panel and analyzing the acquired response data until one or more criteria is reached.

6. The method of claim 5, further including:
terminating the collaboration session after said one or more criteria is reached.

7. The method of claim 1, wherein the response data is acquired via a data acquisition service plug-in to the computer-implemented workspace.

8. The method of claim 1, wherein the virtual expert panel convenes over the Internet.

9. The method of claim 1, wherein the response data is acquired asynchronously from the members of the virtual expert panel.

10. The method of claim 1, further including:
displaying to the members of the virtual expert panel, degree to which each of the members' inputs are different from one another and consensus knowledge derived from all inputs.

11. The method of claim 1, wherein the step of creating at least one data acquisition instrument further includes creating at least one data acquisition instrument that balances data collection.

12. The method of claim 1, wherein the step of creating at least one data acquisition instrument further includes utilizing a dynamic data acquisition plan that assigns question items to the members of the virtual expert panel based on already collected data.

13. The method of claim 1, further including assigning aliases to the members of the virtual expert panel, wherein the members remain anonymous to one another.

14. The method of claim 1, further including storing the acquired response data and data associated with collaboration session, the virtual team and the virtual expert panel.

15. The method of claim 1, wherein the step of analyzing the acquired response data further includes imputing data to augment the acquired response data to provide complete data set for analysis.

16. The method of claim 15, wherein the data is imputed using recursive k nearest neighbor imputation algorithm.

17. A system for collaborative panel administrator, comprising:
a computer platform module operable to provide virtual panel lifecycle management;
a storage device storing a plurality of panel security policies; and
a plurality of service plug-in registry interfaces implemented in the computer platform module for one or more data acquisition services and one or more analysis services to register services with the computer platform module, the computer platform module further operable to invoke the registered data acquisition services and the analysis services based on user requests, and to store and distribute results based on said panel security policies.

18. The system of claim 17, further including:
a graphical user interface for users to access one or more functions of the computer platform module.

19. The system of claim 17, wherein the computer platform module is operable to create a virtual panel and managing lifecycle of the virtual panel.

20. The system of claim 19, wherein the virtual panel includes a plurality of members recruited using the computer platform module.

21. The system of claim 20, wherein said panel security policies include using alias for members of the virtual panel.

22. The system of claim 21, wherein the computer platform module is further operable to utilize a dynamic data acquisition plan that assigns question items to the members of the virtual expert panel based on already collected data for acquiring data.

23. The system of claim 22, wherein the computer platform module is further operable to impute data to augment the acquired data to provide a complete data set for analysis.

24. The system of claim 17, wherein the system is integrated into a collaboration environment.

25. A program storage device readable by a machine, tangibly embodying a program of instructions executable by the machine to perform a method of collaborative panel administrator, comprising:
creating a computer-implemented workspace for collaboration session;
creating a virtual team including at least one administrative user;
creating at least on data acquisition instrument;
creating a virtual expert panel to include members selected according to competency in one or more knowledge domain;
convening the virtual expert panel to acquire response data from the members of the virtual expert panel; and
analyzing the acquired response data.

26. The program storage device of claim 25, wherein the computer platform module further displays to the members of the virtual expert panel via a user interface module, degree to which each of the members' inputs are different from one another and consensus knowledge derived from all inputs.

27. The program storage device of claim 25, wherein the step of creating at least one data acquisition instrument further includes creating at least one data acquisition instrument that balances data collection.

28. The program storage device of claim 25, wherein the step of creating at least one data acquisition instrument further includes utilizing a dynamic data acquisition plan that assigns question items to the members of the virtual expert panel based on already collected data.

29. The program storage device of claim 25, further including assigning aliases to the members of the virtual expert panel, wherein the members remain anonymous to one another.

30. The program storage device of claim 25, wherein the step of analyzing the acquired response data further includes imputing data to augment the acquired response data to provide complete data set for analysis.

31. The method of claim 1, wherein the response data is acquired within a predetermined time boundary.
